(19) United States
(12) Patent Application Publication
(10) Pub. No.: US 2006/0070275 A1
(43) Pub. Date: Apr. 6, 2006

(54) Name card cartridge

(76) Inventor: Tien-Lun Liu, Taichung City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/131,270

(22) Filed: May 18, 2005

(30) Foreign Application Priority Data
Sep. 8, 2004 (TW) 93214347

(51) Int. Cl. G09F 11/00

(52) U.S. Cl. 40/491

(57) ABSTRACT

A name card cartridge including a cartridge body for receiving name cards therein and a cover body pivotally connected with the cartridge body. A bottom face of the cartridge body is printed with a perpetual calendar and two parallel slide slots are formed on the bottom face of the cartridge body. The name card cartridge further includes a frame slidable along the slide slots for checking dates. The name card cartridge is easily portable.

### BACKGROUND OF THE INVENTION

The present invention is related to a name card cartridge which enables a user to conveniently check dates. In addition, the name card cartridge is easily portable.

FIGS. 7 and 8 show a conventional name card cartridge having a name card seat 7 in which name cards can be inserted. A perpetual calendar 8 is printed on one face of the name card seat 7. A slot 81 is formed on lower side of the perpetual calendar 8. An upper and a lower ends of a slider 9 are respectively formed with two hook sections 91. The upper hook section 91 hooks an upper edge of the name card seat 7 and the lower hook section 91 extends through the slot 81, whereby the slider 9 can slide along the name card seat 7 for checking dates. Such name card cartridge has a considerable volume so that it is inconvenient to carry the name card cartridge.

### SUMMARY OF THE INVENTION

It is therefore a primary object of the present invention to provide a multi-use name card cartridge printed with a perpetual calendar. The name card cartridge enables a user to conveniently check dates. In addition, the name card cartridge is easily portable.

According to the above object, the name card cartridge of the present invention includes a cartridge body for receiving name cards therein and a cover body pivotally connected with the cartridge body. A bottom face of the cartridge body is printed with a perpetual calendar and two parallel slide slots are formed on the bottom face of the cartridge body. The name card cartridge further includes a frame slidable along the slide slots. The frame is composed of two opposite longitudinal bars and two opposite transverse bars. Each transverse bar has a moving section corresponding to the slide slot. One face of the moving section is formed with a channel defined between two sidewalls and a bottom wall for sliding along the slide slot. The other face of the moving section is formed with a stepped section opposite to the channel, whereby when the frame slides, the characters of the perpetual calendar will not be worn off by the frame.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 3 is a sectional assembled view of the present invention;

FIG. 4 is an enlarged side view of the frame of the present invention;

FIG. 5 shows the use of the present invention in one state;

FIG. 6 shows the use of the present invention in another state;

FIG. 7 is a perspective view of a conventional name card cartridge; and

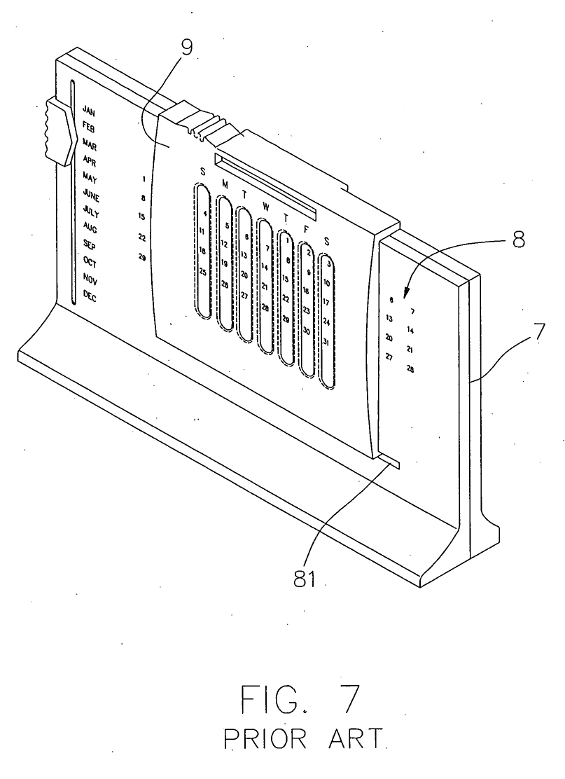

FIG. 8 is a side view of the conventional name card cartridge.

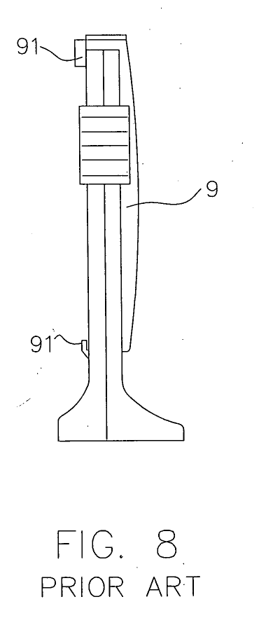

### DETAILED DESCRIPTION OF THE PREFERRED EMBODIMENT

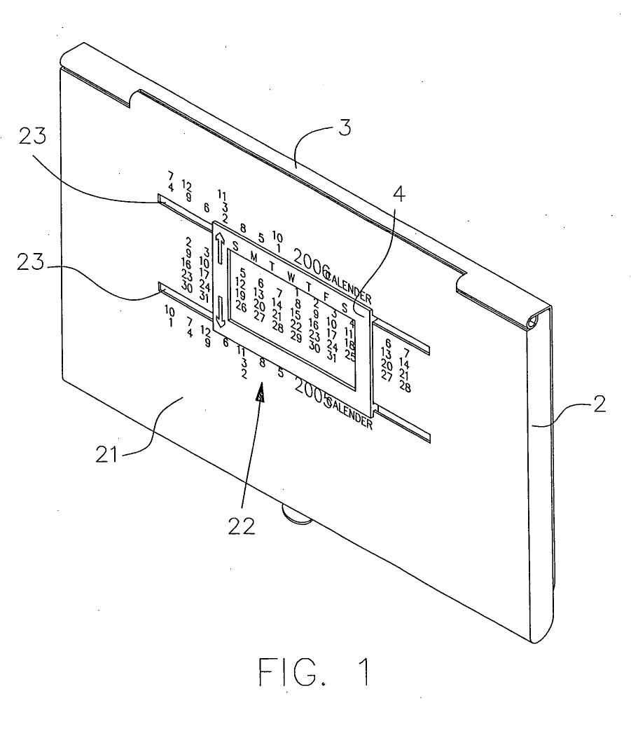

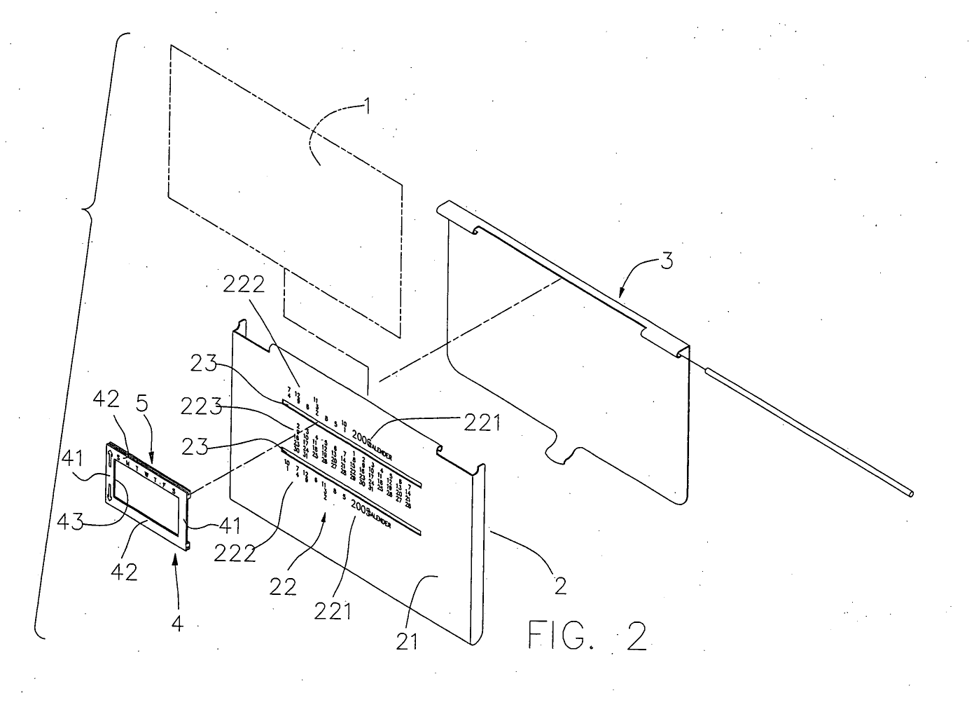

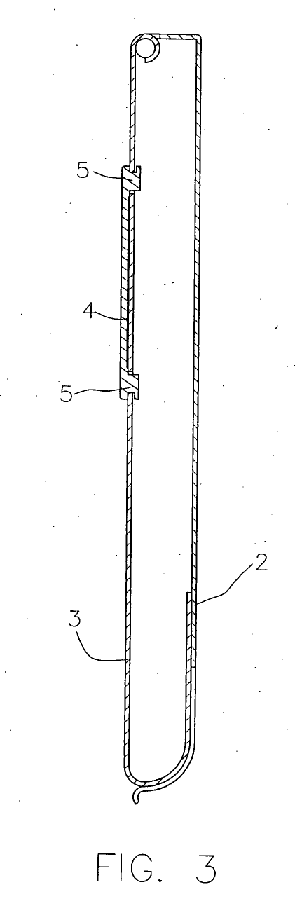

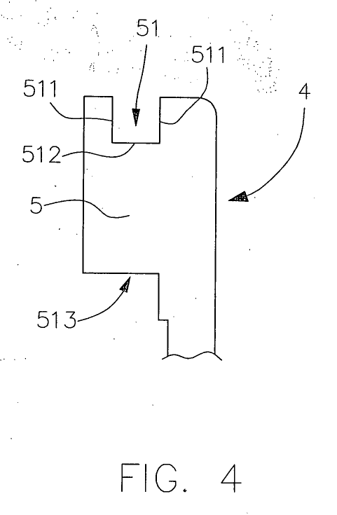

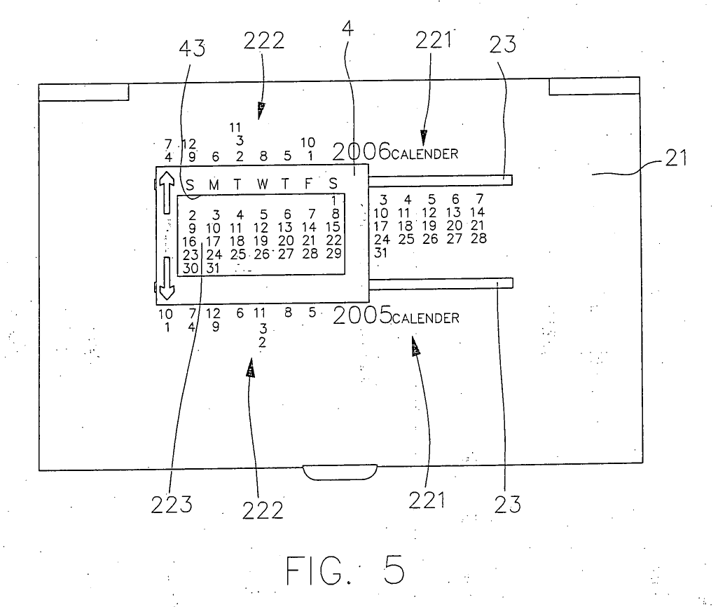

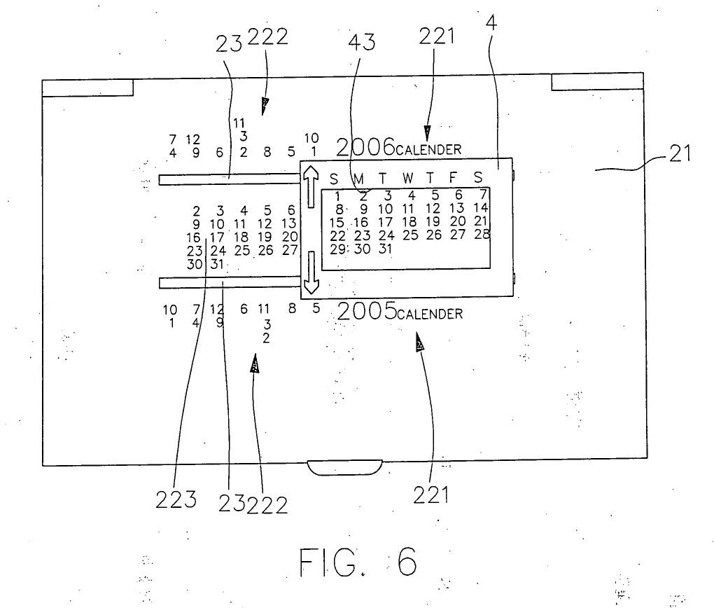

Please refer to FIGS. 1 to 6. The name card cartridge of the present invention includes a cartridge body 2 for receiving name cards 1 therein and a cover body 3 pivotally connected with the cartridge body 2. A bottom face 21 of the cartridge body 2 is printed with a perpetual calendar 22. Two parallel slide slots 23 are formed on the bottom face 21 of the cartridge body 2. A frame 4 is slidable along the slide slots 23. Year section 221 and month section 222 of the perpetual calendar 22 are respectively printed on upper and lower sides of the slide slots 23. A day section 223 of the perpetual calendar 22 is printed between the slide slots 23. The frame 4 has two opposite longitudinal bars 41 and two opposite transverse bars 42 which define a window 43. Each transverse bar 42 has a moving section 5 corresponding to the slide slot 23. One face of the moving section 5 is formed with a channel 51 defined between two sidewalls 511 and a bottom wall 512 for sliding along the slide slot 23. The other face of the moving section 5 is formed with a stepped section 513 opposite to the channel 51, whereby when the frame 4 slides, the characters of the perpetual calendar 22 will not be worn off by the frame 4.

Name cards 1 can be placed in the cartridge body 2. The name card cartridge is lightweight and easily portable. An edge of the slide slot 23 is snugly slidably chucked in the channel 51 of the moving section 5 of the frame 4. Accordingly, the frame 4 can be slid along the slide slots 23 without dropping out. A lower step of the stepped section 513 of the moving section 5 slidably attaches to the bottom face 21. A higher step of the stepped section 513 is spaced from the bottom face 21 by a certain distance. Therefore, when sliding, the frame 4 will not abrade the characters of the perpetual calendar 22 printed on the bottom face 21 of the cartridge body 2. When checking dates, the frame 4 is slid to a checked year section 221 and month section 222. An arrow marked on the frame 4 is directed to a checked month. Accordingly, the date section 223 of the checked month will be shown in the window 43 of the frame 4. Therefore, the weekday of a certain day of a certain month of a certain year can be checked out. A user can easily carry the above name card cartridge and conveniently check out the date.

The above embodiment is only used to illustrate the present invention, not intended to limit the scope thereof. Many modifications of the above embodiment can be made without departing from the spirit of the present invention.

What is claimed is:

1. A name card cartridge comprising a cartridge body for receiving name cards therein and a cover body pivotally connected with the cartridge body, said name card cartridge being characterized in that a bottom face of the cartridge body is printed with a perpetual calendar and two parallel slide slots are formed on the bottom face of the cartridge body, the name card cartridge further comprising a frame slidable along the slide slots, the frame being composed of two opposite longitudinal bars and two opposite transverse bars, each transverse bar having a moving section corresponding to the slide slot, one face of the moving section being formed with a channel defined between two sidewalls and a bottom wall for sliding along the slide slot, the other face of the moving section being formed with a stepped section opposite to the channel, whereby when the frame slides, the characters of the perpetual calendar will not be worn off by the frame.

2. The name card cartridge as claimed in claim 1, wherein the perpetual calendar is printed between the two slide slots.

3. The name card cartridge as claimed in claim 1, wherein the frame defines a window through which the perpetual calendar can be seen.
